(19) United States
(12) Patent Application Publication
(10) Pub. No.: US 2018/0093913 A1
(43) Pub. Date: Apr. 5, 2018

(54) METHODS AND APPARATUSES FOR REMOVING EDGES OF A GLASS RIBBON

(71) Applicant: CORNING INCORPORATED, CORNING, NY (US)

(72) Inventors: Steven Roy Burdette, Big Flats, NY (US); Shriram Palanthandalam Madapusi, Painted Post, NY (US); Ilia Andreyevich Nikulin, Painted Post, NY (US); Xavier Tellier, Cheroy (FR); Rui Zhang, Elmira, NY (US)

(21) Appl. No.: 15/559,239

(22) PCT Filed: Mar. 17, 2016
(86) PCT No.: PCT/US16/22784

§ 371 Date: Sep. 18, 2017

Related U.S. Application Data
(60) Provisional application No. 62/134,827, filed on Mar. 18, 2015.

(51) Int. Cl. C03B 33/02; C03B 33/09; B23K 26/38

(52) U.S. Cl. CPC C03B 33/0215; B23K 2203/54; B23K 26/38; C03B 33/091

(57) ABSTRACT

A method and apparatus for forming a glass ribbon comprising a forming body configured to form a continuously moving glass ribbon that is drawn therefrom, a first heating or cooling apparatus to initiate a crack in a viscoelastic region of the continuously moving glass ribbon, and a second heating or cooling apparatus to locate or stop the initiated crack in the continuously moving glass ribbon.

### CROSS-REFERENCE TO RELATED APPLICATIONS

This application claims the benefit of priority under 35 U.S.C. § 119 of U.S. Provisional Application Ser. No. 62/134,827 filed on Mar. 18, 2015, the content of which is relied upon and incorporated herein by reference in its entirety.

### FIELD OF THE DISCLOSURE

The present disclosure relates generally to glass manufacturing systems and more particularly to cutting a ribbon of glass as well as crack propagation and location or stoppage on a ribbon of glass.

### BACKGROUND

High-performance display devices, such as liquid crystal displays (LCDs) and plasma displays, are commonly used in various electronics, such as cell phones, laptops, electronic tablets, televisions, and computer monitors. Currently marketed display devices can employ one or more high-precision glass sheets, for example, as substrates for electronic circuit components, or as color filters, to name a few applications. The leading technology for making such high-quality glass substrates is the fusion draw process, developed by Corning Incorporated, and described, e.g., in U.S. Pat. Nos. 3,338,696 and 3,682,609, which are incorporated herein by reference in their entireties.

The fusion draw process can utilize a fusion draw machine (FDM) comprising a forming body (e.g., isopipe). The forming body can comprise an upper trough-shaped portion and a lower portion having a wedge-shaped cross-section with two major side surfaces (or forming surfaces) sloping downwardly to join at a root. During the glass forming process, the molten glass can be delivered to one end of the isopipe (“delivery end”) and can travel down the length of the isopipe while flowing over the trough side walls (or weirs) to an opposite end (“compression end”). The molten glass can flow down along the two forming surfaces as two glass ribbons, which ultimately converge at the root where they fuse together to form a unitary glass ribbon. The glass ribbon can thus have two pristine external surfaces that have not been exposed to the surface of the forming body. The ribbon can then be drawn down and cooled to form a glass sheet having a desired thickness and a pristine surface quality.

Forming of flat glass, whether by fusion or another forming process (e.g., float, slot draw, etc.) can result in the formation of thick regions of glass at the edges of an otherwise thin ribbon of glass in the respective manufacturing process. These thick regions of glass are generally called beads. Bead thicknesses can vary from about 3 to 4 times the nominal central ribbon thickness to as high as 10 times the nominal central ribbon thickness. Beads are undesirable as they can cause difficulties in glass forming and can limit product quality. Thus, there is a need to eliminate beads in glass forming processes.

### SUMMARY

The disclosure relates to methods and systems to continuously form and remove a bead from a glass ribbon.

Some embodiments provide an apparatus for forming a glass ribbon comprising a forming body comprising converging forming surfaces that join at a root of the forming body, the forming body configured to have molten glass forming a continuously moving glass ribbon that is drawn from the root, a first heating or cooling apparatus to initiate a vertical crack in the continuously moving glass ribbon, a second heating or cooling apparatus to locate or stop the initiated crack in the continuously moving glass ribbon, and a separating mechanism downstream of the first and second heating or cooling apparatuses, the separating mechanism configured to horizontally separate the continuously moving glass ribbon into glass sheets. In some embodiments, the second heating or cooling apparatus is downstream of the first heating or cooling apparatus. In other embodiments, the first and second heating or cooling apparatuses comprise at least one of a nozzle, jet, a laser, an IR heater and a burner. In some embodiments, the continuously moving glass ribbon is at a first temperature and wherein the first heating or cooling apparatus is configured to deliver gas to the continuously moving glass ribbon at a second temperature lower than the first temperature. In other embodiments, the continuously moving glass ribbon is at a first temperature and wherein the first heating or cooling apparatus is configured to deliver gas to the continuously moving glass ribbon at a second temperature higher than the first temperature. In some embodiments, a third heating or cooling apparatus can either be downstream of the first and second heating or cooling apparatuses or downstream of the first heating and cooling apparatus and upstream of the second heating or cooling apparatus. In other embodiments, the gas is selected from the group consisting of air, nitrogen, hydrogen, combustible gases, noble gases and combinations thereof. In some embodiments, separating mechanism separates the glass using at least one of a laser mechanism, a mechanical scoring mechanism, and one or more additional heating or cooling apparatuses. In other embodiments, the continuously moving glass ribbon has a thickness between about 0.01 mm to about 5 mm. In some embodiments, the second heating mechanism is located between about 2500 mm and about 7500 mm downstream of the root. In other embodiments, the first heating mechanism is located between about 500 mm and about 5500 mm upstream of the second heating mechanism. In some embodiments, a method for manufacturing a glass ribbon is provided using the aforementioned apparatuses.

In additional embodiments, an apparatus for forming a glass ribbon is provided comprising a forming body comprising converging forming surfaces that join at a root of the forming body, the forming body configured to have molten glass forming a continuously moving glass ribbon that is drawn from the root, a first heating or cooling apparatus to separate the continuously moving glass ribbon in the direction of flow, and a second heating or cooling apparatus to locate or stop the separation of the continuously moving glass ribbon before the root. Some embodiments can further comprise a separating mechanism downstream of the first and second heating or cooling apparatuses, the separating mechanism configured to horizontally separate the continuously moving glass ribbon into glass sheets. Additional embodiments can further comprise a third heating or cooling apparatus either downstream of the first and second heating or cooling apparatuses or downstream of the first heating and cooling apparatus and upstream of the second heating or cooling apparatus. In some embodiments, the second heating or cooling apparatus is downstream of the first heating or cooling apparatus. In other embodiments, the first and second heating or cooling apparatuses comprise at least one of a nozzle, jet, a laser, an IR heater and a burner. In some embodiments, the continuously moving glass ribbon is at a first temperature and wherein the first heating or cooling apparatus is configured to deliver gas to the continuously moving glass ribbon at a second temperature lower than the first temperature. In other embodiments, the continuously moving glass ribbon is at a first temperature and wherein the first heating or cooling apparatus is configured to deliver gas to the continuously moving glass ribbon at a second temperature higher than the first temperature. In some embodiments, the gas is selected from the group consisting of air, nitrogen, hydrogen, combustible gases, noble gases and combinations thereof. In other embodiments, the separating mechanism separates the glass using at least one of a laser mechanism, a mechanical scoring mechanism, and one or more additional heating or cooling apparatuses. In some embodiments, the continuously moving glass ribbon has a thickness after the separating mechanism of between about 0.01 mm to about 5 mm. In other embodiments, the second heating mechanism is located between about 2500 mm and about 7500 mm downstream of the root. In some embodiments, the first heating mechanism is located between about 500 mm and about 5500 mm upstream of the second heating mechanism. In other embodiments, a method for manufacturing a glass ribbon is provided using the aforementioned apparatuses.

Yet additional embodiments provide an apparatus for forming a glass ribbon comprising a forming body configured to form a continuously moving glass ribbon that is drawn therefrom, a first heating or cooling apparatus to initiate a crack in a viscoelastic region of the continuously moving glass ribbon, and a second heating or cooling apparatus to locate or stop the initiated crack in the continuously moving glass ribbon. In some embodiments, the forming body further comprises converging forming surfaces that join at a root of the forming body, the forming body being configured to have molten glass forming a continuously moving glass ribbon that is drawn from the root. In other embodiments, the initiated crack is in the direction of flow. In some embodiments, the initiated crack is perpendicular to the direction of flow. Other embodiments can further comprise a separating mechanism downstream of the first and second heating or cooling apparatuses, the separating mechanism configured to horizontally separate the continuously moving glass ribbon into glass sheets. In some embodiments, the second heating or cooling apparatus is downstream of the first heating or cooling apparatus. Other embodiments can comprise a third heating or cooling apparatus either downstream of the first and second heating or cooling apparatuses or downstream of the first heating and cooling apparatus and upstream of the second heating or cooling apparatus. In some embodiments, the first and second heating or cooling apparatuses comprise at least one of a nozzle, jet, a laser, an IR heater and a burner. In other embodiments, the continuously moving glass ribbon is at a first temperature and wherein the first heating or cooling apparatus is configured to deliver gas to the continuously moving glass ribbon at a second temperature lower than the first temperature. In some embodiments, the continuously moving glass ribbon is at a first temperature and wherein the first heating or cooling apparatus is configured to deliver gas to the continuously moving glass ribbon at a second temperature higher than the first temperature. In other embodiments, the gas is selected from the group consisting of air, nitrogen, hydrogen, combustible gases, noble gases and combinations thereof. In some embodiments, the separating mechanism separates the glass using at least one of a laser mechanism, a mechanical scoring mechanism, and one or more additional heating or cooling apparatuses. In other embodiments, the continuously moving glass ribbon has a thickness of between about 0.01 mm to about 5 mm. In some embodiments, the second heating mechanism is located between about 2500 mm and about 7500 mm downstream of the root. In other embodiments, the first heating mechanism is located between about 500 mm and about 5500 mm upstream of the second heating mechanism. In other embodiments, a method for manufacturing a glass ribbon is provided using the aforementioned apparatuses.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be best understood when read in conjunction with the following drawings, where like structures are indicated with like reference numerals where possible and in which:

FIG. 1 is a schematic of an exemplary forming body for use in an exemplary fusion draw process for making a glass ribbon;

FIG. 2 is a cross-sectional view of the forming body of FIG. 1;

FIG. 3 is a schematic of an exemplary glass manufacturing system;

FIG. 4 is a side view of some embodiments of the present subject matter;

FIG. 5 is a perspective view of some embodiments of an exemplary nozzle mechanism;

FIG. 6 is a schematic of a through crack of length a in a specimen subjected to uniform tension stress a;

FIG. 7 is a schematic of crack stoppage for a specimen;

FIG. 8 is a series of stress diagrams showing cooling at certain elevations on a glass ribbon to create residual stress and cooling or heating at various locations for crack location or stoppage;

FIG. 9 is a graph showing a thermal model for a crack locating or stopping burner, nozzle, or jet;

FIG. 10 is a thermal-mechanical graphical analysis of a glass ribbon with a crack locating or stopping burner, nozzle, or jet;

FIG. 11 is a series of plots illustrating temperature differences and induced residual stresses in a glass ribbon due to thinning on a side thereof;

FIG. 12 is another series of plots illustrating temperature differences and induced residual stresses in a glass laminate ribbon due to thinning on a side thereof; and

FIGS. 13 and 14 are plots of compressive stress in a laminate ribbon.

### DETAILED DESCRIPTION

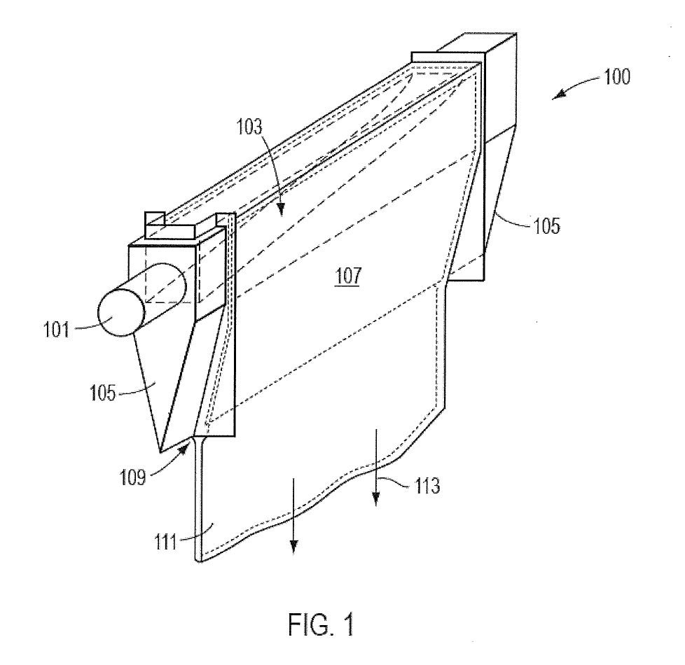

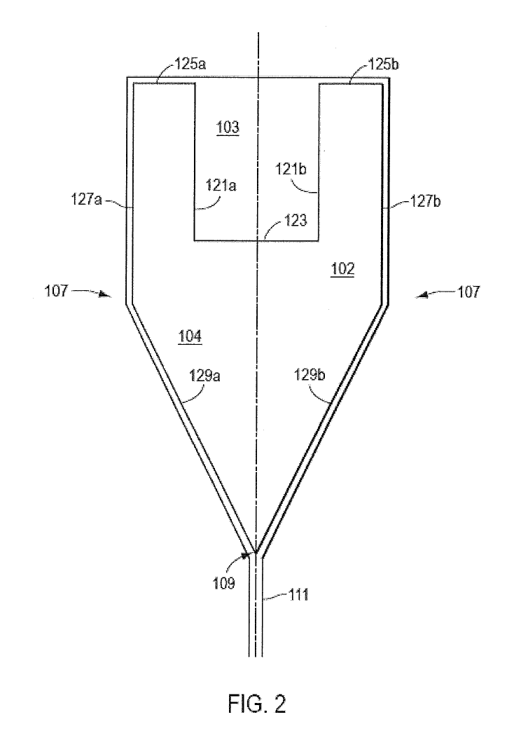

Disclosed herein are systems and apparatuses for producing a glass ribbon. Embodiments of the disclosure will be discussed with reference to FIGS. 1-2, which depict an exemplary forming body, e.g., isopipe, suitable for use in an exemplary glass manufacturing process for producing a glass ribbon. Referring to FIG. 1, during a glass manufacturing process, such as a fusion draw process, molten glass can be introduced into a forming body 100 comprising a trough 103 via an inlet pipe 101. Of course, the claims appended herewith should not be limited to a fusion draw process as the claimed subject matter can be employed in any glass manufacturing process having a continuous ribbon of glass including slot draw, float, redraw, and other processes. Once the trough 103 is filled completely, the molten glass can overflow over the sides of the trough and down the two opposing forming surfaces 107 before fusing together at the root 109 to form a glass ribbon 111. The glass ribbon can then be drawn down in the direction 113 using, e.g., a roller assembly (not shown) and further processed to form a glass sheet. The forming body assembly can further comprise ancillary components such as end caps 105 and/or edge directors (not shown).

FIG. 2 provides a cross-sectional view of the forming body of FIG. 1, in which the forming body 100 can comprise an upper trough-shaped part 102 and a lower wedge-shaped part 104. The upper trough-shaped part 102 can comprise a channel or trough 103 configured to receive the molten glass. The trough 103 can be defined by two trough walls (or weirs) 125a, 125b comprising interior surfaces 121a, 121b, and a trough bottom 123. Although the trough is depicted as having a rectangular cross-section, with the interior surfaces forming approximately 90-degree angles with the trough bottom, other trough cross-sections are envisioned, as well as other angles between the interior surfaces and the bottom of the trough. The weirs 125a, 125b can further comprise exterior surfaces 127a, 127b which, together with the wedge outer surfaces 129a, 129b, can make up the two opposing forming surfaces 107. Molten glass can flow over the weirs 125a, 125b and down the forming surfaces 107 as two glass ribbons which can then fuse together at the root 109 to form a unitary glass ribbon 111. The ribbon can then be drawn down in direction 113 and, in some embodiments, further processed to form a glass sheet.

The forming body 100 can comprise any material suitable for use in a glass manufacturing process, for example, refractory materials such as zircon, zirconia, alumina, magnesium oxide, silicon carbide, silicon nitride, silicon oxynitride, xenotime, monazite, alloys thereof, and combinations thereof. According to various embodiments, the forming body may comprise a unitary piece, e.g., one piece machined from a single source. In other embodiments, the forming body may comprise two or more pieces bonded, fused, attached, or otherwise coupled together, for instance, the trough-shaped portion and wedge-shaped portion may be two separate pieces comprising the same or different materials. The dimensions of the forming body, including the length, trough depth and width, and wedge height and width, to name a few, can vary depending on the desired application. It is within the ability of one skilled in the art to select these dimensions as appropriate for a particular manufacturing process or system.

While not shown, an exemplary forming body 100 can be equipped with pier blocks (or supports), which may be in contact with, e.g., the lower wedge-shaped portion 104 of the forming body 100. The pier blocks can be used to apply a compressive force to the forming body 100 at one or both ends. Pier seats (e.g., cut-outs or recesses) can be present in the forming body 100, for receiving the pier blocks and can have a substantially square or rectangular shape and the pier blocks can, in some embodiments, have a corresponding shape. For example, the pier blocks can be chamfered or beveled to create discontinuous contact between the pier block and the pier seat or the pier blocks and/or pier seats can also be curvilinear. The pier blocks can comprise any material suitable for use in a glass manufacturing process, for example, refractory materials such as those described above with respect to the forming body, e.g., zircon, zirconia, alumina, magnesium oxide, silicon carbide, silicon nitride, silicon oxynitride, xenotime, monazite, alloys thereof, and combinations thereof. In other embodiments, the pier blocks can comprise different materials than those used in a respective and adjacent forming body.

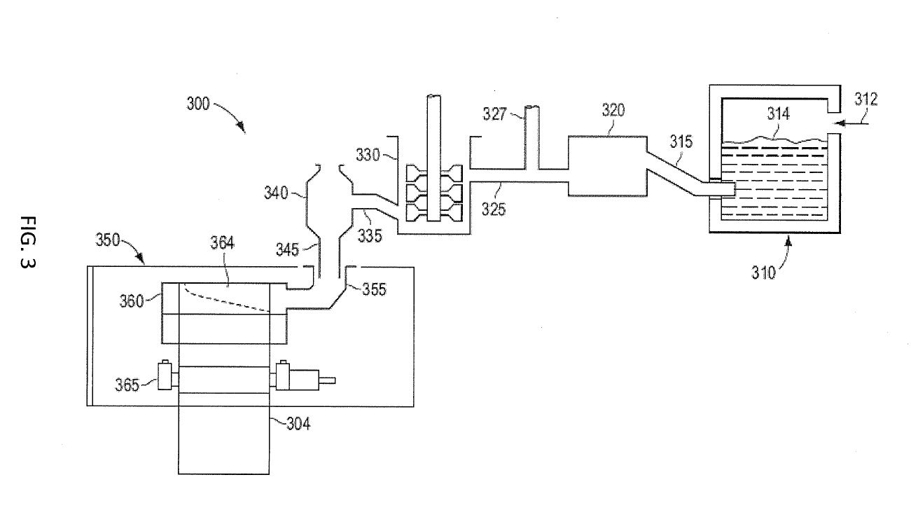

Embodiments of the disclosure are also discussed with reference to FIG. 3, which depicts an exemplary glass manufacturing system 300 for producing a glass ribbon 304. Again, while FIG. 3 illustrates a fusion draw process, the claims appended herewith should not be so limited as the claimed subject matter can be employed in any glass manufacturing process having a continuous ribbon of glass including slot draw, float, redraw, and other processes. The glass manufacturing system 300 can include a melting vessel 310, a melting to fining tube 315, a fining vessel (e.g., finer tube) 320, a fining to stir chamber connecting tube 325 (with a level probe stand pipe 327 extending therefrom), a stir chamber (e.g., mixing vessel) 330, a stir chamber to bowl connecting tube 335, a bowl (e.g., delivery vessel) 340, a downcomer 345, and a fusion draw machine (FDM) 350, which can include an inlet 355, a forming body (e.g., isopipe) 360, and a pull roll assembly 365.

Glass batch materials can be introduced into the melting vessel 310, as shown by arrow 312, to form molten glass 314. The fining vessel 320 is connected to the melting vessel 310 by the melting to fining tube 315. The fining vessel 320 can have a high temperature processing area that receives the molten glass from the melting vessel 310 and which can remove bubbles from the molten glass. The fining vessel 320 is connected to the stir chamber 330 by the fining to stir chamber connecting tube 325. The stir chamber 330 is connected to the bowl 340 by the stir chamber to bowl connecting tube 335. The bowl 340 can deliver the molten glass through the downcomer 345 into the FDM 350.

The term “batch materials” and variations thereof are used herein to denote a mixture of glass precursor components which, upon melting, react and/or combine to form a glass. The glass batch materials may be prepared and/or mixed by any known method for combining glass precursor materials. For example, in certain non-limiting embodiments, the glass batch materials can comprise a dry or substantially dry mixture of glass precursor particles, e.g., without any solvent or liquid. In other embodiments, the glass batch materials may be in the form of a slurry, for example, a mixture of glass precursor particles in the presence of a liquid or solvent. According to various embodiments, the batch materials may comprise glass precursor materials, such as silica, alumina, and various additional oxides, such as boron, magnesium, calcium, sodium, strontium, tin, or titanium oxides. For instance, the glass batch materials may be a mixture of silica and/or alumina with one or more additional oxides. In various embodiments, the glass batch materials comprise from about 45 to about 95 wt % collectively of alumina and/or silica and from about 5 to about 55 wt % collectively of at least one oxide of boron, magnesium, calcium, sodium, strontium, tin, and/or titanium. The batch materials can be melted according to any method known in the art, including the methods discussed herein with reference to FIG. 3. For example, the batch materials can be added to a melting vessel and heated to a temperature ranging from about 1100° C. to about 1700° C., such as from about 1200° C. to about 1650° C., from about 1250° C. to about 1600° C., from about 1300° C. to about 1550° C., from about 1350° C. to about 1500° C., or from about 1400° C. to about 1450° C., including all ranges and subranges therebetween. The batch materials may, in certain embodiments, have a residence time in the melting vessel ranging from several minutes to several hours, depending on various variables, such as the operating temperature and the batch size. For example, the residence time may range from about 30 minutes to about 8 hours, from about 1 hour to about 6 hours, from about 2 hours to about 5 hours, or from about 3 hours to about 4 hours, including all ranges and subranges therebetween.

With continued reference to FIG. 3, the FDM 350 can include an inlet 355, a forming body 360, and a pull roll assembly 365. The inlet 355 can receive the molten glass from the downcomer 345, from which it can flow to the forming body 360, where it is formed into a glass ribbon 304. The pull roll assembly 365 can deliver the drawn glass ribbon 304 for further processing by additional optional apparatuses. For example, the glass ribbon can be further processed by a traveling anvil machine (TAM), which can include a mechanical scoring device for scoring the glass ribbon or processes by laser mechanisms to similarly cut or score the glass ribbon. The scored glass can then be separated into pieces of glass sheet, machined, polished, chemically strengthened, and/or otherwise surface treated, e.g., etched, using various methods and devices known in the art. Conventionally, edge portions or beads are separated from the glass sheet subsequent to the processing by the TAM in a finishing line or portion of the glass manufacturing system (not shown). Such conventional means to separate edge portions or beads include laser separation and/or mechanical scoring methods and devices known in the art.

The molten glass can also undergo various additional processing steps, including fining to remove bubbles, and stirring to homogenize the glass melt, to name a few. The molten glass can then be processed to produce a glass ribbon using the forming body disclosed herein. For example, as discussed above, the molten glass can be introduced into the trough-shaped portion of the forming body at the delivery end via one or more inlets. The glass can flow in a direction proceeding from the delivery end to the compression end, over the two trough walls, and down the two opposing outer surfaces of the wedge-shaped portion, converging at the root to form a unitary glass ribbon.

By way of a non-limiting example, the forming body apparatus may also be enclosed in a vessel operating at a temperature ranging, at its hottest point (e.g., in an upper “muffle” region proximate the trough-shaped portion), from about 1100° C. to about 1350° C., such as from about 1150° C. to about 1325° C., from about 1150° C. to about 1300° C., from about 1175° C. to about 1250° C., or from about 1200° C. to about 1225° C., including all ranges and subranges therebetween. At its coolest point (e.g., in a lower “transition” region proximate the root of the forming body), the vessel may operate at a temperature ranging from about 800° C. to about 1250° C., such as from about 850° C. to about 1225° C., from about 900° C. to about 1200° C., from about 950° C. to about 1150° C., or from about 1000° to about 1100° C., including all ranges and subranges therebetween.

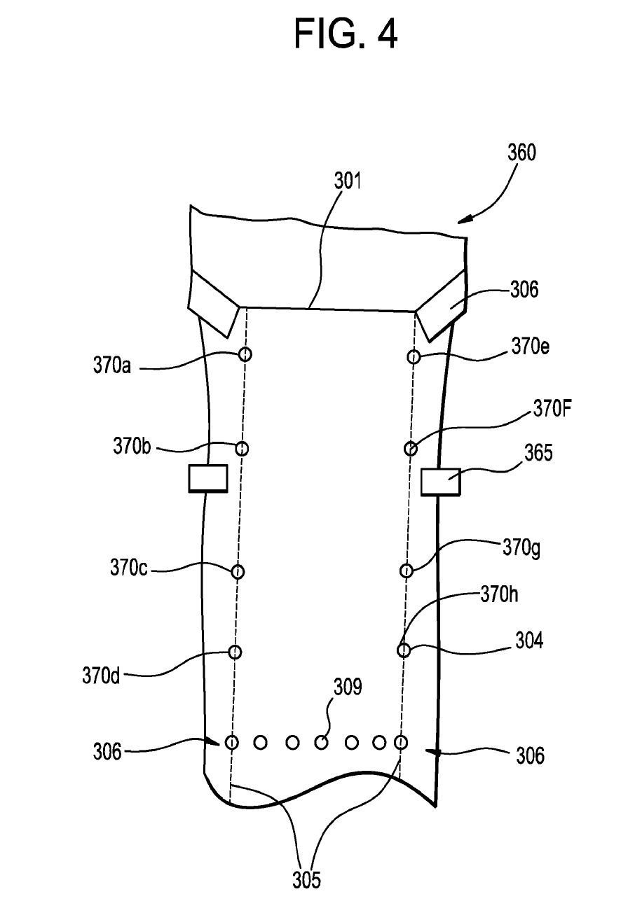

With continued reference to FIG. 3, exemplary embodiments described herein, rather than separate beads or edge portions of a glass sheet after horizontal separation by a mechanical scoring mechanism or laser mechanism, can initiate and locate or stop a crack in a glass ribbon at any suitable location on the glass ribbon 304 in the FDM 350 prior to cutting thereof with the TAM, a laser cutting mechanism, or other suitable cutting mechanism. It should be noted that the term “initiate” means to cause to begin and/or to confine. For example, in some embodiments a crack can be initiated or caused to begin and/or confined in a glass ribbon. For example, FIG. 4 is a side view of some embodiments of the present subject matter. With reference to FIG. 4, molten glass can be supplied to an exemplary forming body 360 which overflows the walls thereof separating into two individual flows of molten glass that flow over the converging forming surfaces to a root 301 of the forming body 360. When the separate flows of molten glass reach the root 301 of the forming body 360, they recombine to form the glass ribbon 304 that descends from the root of the forming body 360. Edge directors 306 may be positioned on the forming body 360 to extend the width of the root 301 and thereby aid in widening the glass ribbon 304 or, at a minimum, act to minimize narrowing of the glass ribbon 304. In operation there are typically four edge directors 306, two edge directors opposing each other at one end of the forming body and another pair of opposing edge directors positioned at the opposite end of the forming body; however, as FIG. 4 is a perspective view of an exemplary forming body 360, two of the edge directors are hidden from view.

As the glass ribbon 304 descends from the root, pulling rolls 365 contact the viscous glass ribbon along the edges thereof and aid in drawing the ribbon in a downward path. Pulling rolls 365 comprise opposing, counter-rotating rollers that grip the glass ribbon 304 at edge portions thereof and draw the glass ribbon downward. While not shown, additional driven or non-driven rolls positioned above and/or below the pulling rolls 365 may also contact the edges of the glass ribbon 304 to aid in guiding the ribbon and maintaining a width of the ribbon against naturally occurring surface tension effects that work to otherwise reduce the width of the ribbon. Further, any number of the illustrated and/or additional driven or non-driven rolls may be canted or angled with respect to the horizontal.

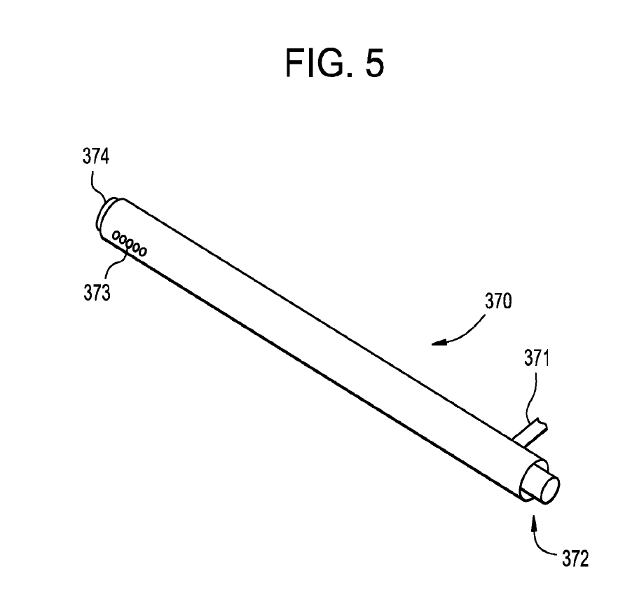

A plurality of cooling or heating nozzles, burners, lasers, IR heaters or jets 370a-h may be positioned within an exemplary FDM 350 whereby each can be supplied with a cooling gas or heating gas. Exemplary gases include, but are not limited to, air, nitrogen, hydrogen, noble gases, other, combustible gases, combinations thereof, and the like. Of course, heating nozzles, burners or jets are exemplary only and the claims should not be so limited as a variety of other mechanisms can be used. For example, in some embodiments lasers, IR heaters or the like can be employed in a heating apparatus or mechanism for the same purpose. In additional embodiments, the supplied gas may be cooled, mixed and/or heated prior to delivery to the respective heating nozzles, burners or jets 370a-h. In exemplary embodiments, a plurality of heating or cooling nozzles 370a-h may be configured to direct heated or cooled air at specific portions of the continuously moving glass ribbon 304 along a predetermined portion, line or area 305 of the ribbon. Generally, vertical separation (e.g., separation in the direction of flow) of this predetermined portion 305 of the glass ribbon would necessarily remove the outermost portion or edge 306 of the glass ribbon containing undesirable beads. In some embodiments, an exemplary heating or cooling nozzle, jet or burner 370 a-h can provide a combustible mixture thereby providing a flame to an adjacent, flowing glass ribbon. FIG. 5 is a perspective view of some embodiments of an exemplary nozzle mechanism. With reference to FIG. 5, an exemplary nozzle, jet or burner 370 can include one or more inlet or feed lines 371 at a proximate end 372 supplying one or more gases to the nozzle, jet or burner 370 and one or a plurality of nozzles, holes or jets 373 at a distal end 374 for supplying a flame, heated air, cooled air, a jet of heated or cooled air, etc. to an adjacent, flowing glass ribbon (not shown). Of course, the embodiment illustrated in FIG. 5 should not limit the scope of the claims appended herewith as it is envisioned that a variety of gas delivery devices can be employed in Applicant's glass manufacturing system to initiate and locate or stop cracks in a continuous glass ribbon. The supplied gas may be provided at a temperature in a range from about 20° C. to about 1700° C., in a range from about 500° C. to about 1700° C., in a range from about 700° C. to about 1700° C., in a range from about 750° C. to about 850° C., in a range from about 850° C. to about 1450° C., in a range from about 1450° C. to about 1700° C., and all subranges therebetween. The supplied (heating or cooling) gas may also be provided at a temperature difference (above or below) with the continuous glass ribbon of between about +/−0.1° C. to about 900° C. and all ranges and subranges therebetween. Such temperatures and temperature differences can be employed by exemplary embodiments to modify compressive or tensile stresses in a glass ribbon from between about 0.1 MPa to greater than about 50 MPa, between about 1 MPa and about 25 MPa, or between about 5 MPa and about 20 MPa and all subranges therebetween. As illustrated in FIG. 4, exemplary nozzles, burners or jets 370a-h can be positioned at or near the root 301 of the forming body 360 inward of an edge of the glass ribbon 304 (e.g., between an edge and centerline of the glass ribbon). In some embodiments, the crack initiating nozzle, burner or jet 370a-h can be located between about 2500 mm and about 7500 mm downstream of the root. In some embodiments, the location can be between about 1000 mm to about 8000 mm, between about 2000 mm to about 7000 mm, between about 3000 mm to about 6000 mm, or between about 4000 mm to about 5000 mm downstream of the root, and all subranges therebetween. In other embodiments, the crack arresting nozzle burner or jet 370a-h can be located at the root and between about 500 mm and about 5500 mm upstream of the crack initiating nozzle. In additional embodiments, the location can be between about 100 mm to about 6000 mm, between about 500 mm to about 5500 mm, between about 1000 mm to about 5000 mm, or between about 2000 mm to about 4000 mm upstream of the crack initiating nozzle, and all subranges therebetween. Exemplary nozzles, burners or jets 370a-h can be positioned anywhere along the glass ribbon between the root 301 and a downstream cutting mechanism (not shown) such as a horizontal mechanical or laser scoring/cutting mechanism. In another embodiment, exemplary nozzles, burners or jets or an array of such devices 309 can be arranged horizontally or perpendicular to the direction of glass flow to replace the downstream cutting mechanism using the same principles described herein. The gas emitted by the nozzles, burners or jets 370, 309 impinges on the glass ribbon and can locally modify the viscosity of the glass causing localized thinning and/or changes in the compressive stress thereof. It is also envisioned that exemplary nozzles, burners, or jets 370, 309 can be movable rather than fixed to change their respective position on the ribbon and to alter the amount of ribbon displaced or location of cut. While not shown, additional mechanisms (mechanical or otherwise) can be employed downstream of exemplary heating and cooling mechanisms 370a-h to displace the separated bead outside of a plane formed by the glass ribbon to avoid any ribbon edge damage and avoid motion of the beads due to downstream operations.

Of course, the illustrations should be exemplary only and should not limit the scope of the claims herewith as exemplary heaters and coolers (as well as other mechanisms) and the locations thereof can be used in embodiments to initiate, propagate and stop or locate a crack on a glass ribbon. For example, in some embodiments, a set of heating mechanisms 370a,e can be provided having an upper boundary close to the root and a lower boundary from about 25 mm to about 100 mm below the root. In some embodiments this upper boundary can be about 100 mm above the root as some experiments have shown that an exemplary location about the root can transfer energy from the surface of the glass to the whole thickness and can be used to efficiently thin the glass. This heating mechanism would be provided at a temperature above the melting temperature of the glass (T_{glass}) to lower the viscosity of the glass ribbon and thin the glass ribbon in selected portions thereof. Further, this heating mechanism could be employed to create a thin lane in the glass ribbon that would induce a low amplitude residual compressive stress below the viscoelastic zone and can direct or control crack propagation vertically and can confine a crack. Such an exemplary heating mechanism should generally be operating at all times during operation of an exemplary glass manufacturing system. This heating mechanism can generally be employed to cause thinning and, if it uses gases, the gas temperature should be at least 100° C. above to at least 200° C. above the glass temperature at flow viscosity of about 150,000 poise or for glasses having a viscosity of about 140,000 poise, the temperature range should be from about 1040° C. to 1240° C. A first set of cooling mechanisms 370b,f can then be provided with an upper boundary of about 300 mm upstream from an upper setting zone boundary or about 200 mm downstream from the heating mechanism 370a,e, whichever is further downstream and can be provided with a lower boundary about 300 mm downstream from where the zone starts. Generally, the location of the setting zone depends upon the ribbon cooling rate. This first set of cooling mechanisms 370 b,f would be provided at a temperature below the melting temperature of the glass (T_{glass}) to create a cooled lane and to increase the amplitude of the induced stress. This first set of cooling mechanisms 370b,f would be aligned with the thin or cooled lane from the mechanisms 370a,e. It may also be desirable to maintain the stress (compressive or tensile) band at the exit of the FDM for the crack initiation and allow upstream propagation of the crack. Such an exemplary first cooling mechanism should generally be operating before crack initiation and can then be kept operating when necessary. Generally, glass transition temperatures range from about 630° C. to about 830° C. Setting zones are generally about +/−65° C. from the glass transition temperature, thus, the temperature of gases from the first set of cooling mechanisms should be about 100° C. below the glass temperature, which is about 650° C. to about 950° C. at the first set of cooling mechanisms. A second set of cooling mechanisms 370c,g can then be aligned with the cooled lane and can be provided with an upper boundary at the location of the glass transition temperature and with a lower boundary anywhere downstream from the glass transition temperature (e.g., for downdraw fusion forming, this location may be +/−100 mm of the downstream setting zone boundary). This second set of cooling mechanisms 370c,g would be provided at a temperature below the melting temperature of the glass (T_{glass}) to manipulate the induced stress and may be used to stop the crack at a defined location. Such an exemplary second cooling mechanism should generally be operating at all times during operation of an exemplary glass manufacturing system. Additional mechanisms (mechanical or otherwise) can be employed downstream of exemplary heating and cooling mechanisms 370 to displace the separated bead outside of a plane formed by the glass ribbon to avoid any ribbon edge damage and avoid motion of the beads due to downstream operations. These additional mechanisms should be activated after crack initiation and then kept operating at all times, and in some embodiments can be placed about 500 mm to 1000 mm downstream of the second set of cooling mechanisms.

In additional embodiments, in some embodiments, a first set of heating mechanisms 370a,e can be provided having an upper boundary close to the root and a lower boundary about 25 mm to about 100 mm below the root. In some embodiments this upper boundary can be about 100 mm above the root as some experiments have shown that an exemplary location about the root can transfer energy from the surface of the glass to the whole thickness and can be used to efficiently thin the glass. This first set of heating mechanisms would be provided at a temperature above the melting temperature of the glass (T_{glass}) to lower the viscosity of the glass ribbon and thin the glass ribbon in selected portions thereof. Further, this first set of heating mechanisms could be employed to create a thin lane in the glass ribbon that would induce a low amplitude residual compressive stress below the viscoelastic zone and can direct or control crack propagation vertically and can confine a crack. Such exemplary heating mechanisms should generally be operating at all times during operation of an exemplary glass manufacturing system. This heating mechanism can generally be employed to cause thinning and, if it uses gases, the gas temperature should be at least 100° C. above to at least 200° C. above the glass temperature at flow viscosity of about 150,000 poise or for glasses having a viscosity of about 140,000 poise, the temperature range should be from about 1040° C. to 1240° C. A set of cooling mechanisms 370b,f can then be provided with an upper boundary of about 300 mm upstream from an upper setting zone boundary or about 200 mm downstream from the heating mechanism 370a,e, whichever is further downstream and can be provided with a lower boundary about 300 mm downstream from where the zone starts. Generally, the location of the setting zone depends upon the ribbon cooling rate. This set of cooling mechanisms 370 b,f would be provided at a temperature below the melting temperature of the glass (T_{glass}) to create a cooled lane and to increase the amplitude of the induced stress. This first set of cooling mechanisms 370b,f would be aligned with the thin or cooled lane from the mechanisms 370a,e. It may also be desirable to maintain the stress (compressive or tensile) band at the exit of the FDM for the crack initiation and allow upstream propagation of the crack. Such exemplary cooling mechanisms should generally be operating before crack initiation and can then be kept operating when necessary. Generally, glass transition temperatures range from about 630° C. to about 830° C. Setting zones are generally about +/−65° C. from the glass transition temperature, thus, the temperature of gases from the set of cooling mechanisms should be about 100° C. below the glass temperature, which is about 650° C. to about 950° C. at the set of cooling mechanisms. A second set of heating mechanisms 370c,g can then be located on both sides of the cooled lane and can be provided with an upper boundary at the location of the glass transition temperature and with a lower boundary anywhere downstream from the glass transition temperature (e.g., for downdraw fusion forming, this location may be +/−100 mm of the downstream setting zone boundary). This second set of heating mechanisms 370c,g would be provided at a temperature above (e.g., 100° C. or more) the melting temperature of the glass (T_{glass}) to manipulate the induced stress and may be used to stop the crack at a defined location. Such exemplary second heating mechanisms should generally be activated just before crack initiation and kept operating at all times during operation of an exemplary glass manufacturing system. Additional mechanisms (mechanical or otherwise) can be employed downstream of exemplary heating and cooling mechanisms 370 to displace the separated bead outside of a plane formed by the glass ribbon to avoid any ribbon edge damage and avoid motion of the beads due to downstream operations. These additional mechanisms should be activated after crack initiation and then kept operating at all times, and in some embodiments can be placed about 500 mm to 1000 mm downstream of the second set of cooling mechanisms.

In further embodiments, a set of heating mechanisms 370a,e can be provided having an upper boundary close to the root and a lower boundary about 25 mm to about 100 mm below the root. In some embodiments this upper boundary can be about 100 mm above the root as some experiments have shown that an exemplary location about the root can transfer energy from the surface of the glass to the whole thickness and can be used to efficiently thin the glass. This heating mechanism would be provided at a temperature above the melting temperature of the glass (T_{glass}) to lower the viscosity of the glass ribbon and thin the glass ribbon in selected portions thereof. Further, this heating mechanism could be employed to create a thin lane in the glass ribbon that would induce a low amplitude residual compressive stress below the viscoelastic zone. Such an exemplary heating mechanism should generally be operating at all times during operation of an exemplary glass manufacturing system. This heating mechanism can generally be employed to cause thinning and, if it uses gases, the gas temperature should be at least 100° C. above to at least 200° C. above the glass temperature at flow viscosity of about 150,000 poise or for glasses having a viscosity of about 140,000 poise, the temperature range should be from about 1040° C. to 1240° C. A set of cooling mechanisms 370b,f can then be provided with an upper boundary of about 300 mm upstream from an upper setting zone boundary or about 200 mm downstream from the heating mechanism 370a,e, whichever is further downstream and can be provided with a lower boundary about 300 mm downstream from where the zone starts. Generally, the location of the setting zone depends upon the ribbon cooling rate. This set of cooling mechanisms 370 b,f would be provided at a temperature below the melting temperature of the glass (T_{glass}) to create a cooled lane and to increase the amplitude of the induced stress. It may also be desirable to maintain the stress (compressive or tensile) band at the exit of the FDM for the crack initiation and allow upstream propagation of the crack. Such exemplary cooling mechanisms should generally be operating before crack initiation and can then be kept operating when necessary. Generally, glass transition temperatures range from about 630° C. to about 830° C. Setting zones are generally about +/−65° C. from the glass transition temperature, thus, the temperature of gases from the set of cooling mechanisms should be about 100° C. below the glass temperature, which is about 650° C. to about 950° C. at the set of cooling mechanisms. Additional mechanisms (mechanical or otherwise) can be employed downstream of exemplary heating and cooling mechanisms 370 to displace the separated bead outside of a plane formed by the glass ribbon to avoid any ribbon edge damage and avoid motion of the beads due to downstream operations. These additional mechanisms should be activated after crack initiation and then kept operating at all times, and in some embodiments can be placed about 500 mm to 1000 mm downstream of the second set of cooling mechanisms.

In some embodiments, no heating mechanisms are used; however, a first set of cooling mechanisms 370b,f can be provided with an upper boundary of about 300 mm upstream from an upper setting zone boundary or about 300 mm downstream from where the zone starts. Generally, the location of the setting zone depends upon the ribbon cooling rate. This first set of cooling mechanisms 370 b,f would be provided at a temperature below the melting temperature of the glass (T_{glass}) to create a cooled lane and to increase the amplitude of the induced stress. This first set of cooling mechanisms can also be used to direct crack propagation vertically and confine the crack. Such an exemplary first cooling mechanism should be kept operating at all times during operation of an exemplary glass manufacturing system. Generally, glass transition temperatures range from about 630° C. to about 830° C. Setting zones are generally about +/−65° C. from the glass transition temperature, thus, the temperature of gases from the first set of cooling mechanisms should be about 100° C. below the glass temperature, which is about 650° C. to about 950° C. at the first set of cooling mechanisms. A second set of cooling mechanisms 370c,g can then be aligned with the residual stress lane and can be provided with an upper boundary at the location of the glass transition temperature and with a lower boundary anywhere downstream from the glass transition temperature (e.g., for downdraw fusion forming, this location may be +/−100 mm of the downstream setting zone boundary). This second set of cooling mechanisms 370c,g would be provided at a temperature below the melting temperature of the glass (T_{glass}) to manipulate the induced stress and may be used to stop the crack at a defined location. Such an exemplary second cooling mechanism should generally be operating at all times during operation of an exemplary glass manufacturing system. Additional mechanisms (mechanical or otherwise) can be employed downstream of exemplary cooling mechanisms 370 to displace the separated bead outside of a plane formed by the glass ribbon to avoid any ribbon edge damage and avoid motion of the beads due to downstream operations. These additional mechanisms should be activated after crack initiation and then kept operating at all times, and in some embodiments can be placed about 500 mm to 1000 mm downstream of the second set of cooling mechanisms.

In yet further embodiments, a set of cooling mechanisms 370b,f can be provided with an upper boundary upstream from an upper setting zone boundary or about 200 mm downstream from where the zone starts. Generally, the location of the setting zone depends upon the ribbon cooling rate. This set of cooling mechanisms 370 b,f would be provided at a temperature below the melting temperature of the glass (T_{glass}) to create a cooled lane and to increase the amplitude of the induced stress. This set of cooling mechanisms can also be used to direct crack propagation vertically and confine the crack. Such an exemplary first cooling mechanism should be kept operating at all times during operation of an exemplary glass manufacturing system. Generally, glass transition temperatures range from about 630° C. to about 830° C. Setting zones are generally about +/−65° C. from the glass transition temperature, thus, the temperature of gases from the set of cooling mechanisms should be about 100° C. below the glass temperature, which is about 650° C. to about 950° C. at the set of cooling mechanisms. A set of heating mechanisms 370c,g can then be aligned with or placed on both sides of the residual stress lane and can be provided with an upper boundary at the location of the glass transition temperature and with a lower boundary anywhere downstream from the glass transition temperature (e.g., for downdraw fusion forming, this location may be +/−100 mm of the downstream setting zone boundary). This set of heating mechanisms 370c,g would be provided at a temperature above (e.g., 100° C. or more) the melting temperature of the glass (T_{glass}) to manipulate the induced stress and may be used to stop the crack at a defined location. Such an exemplary heating mechanism should generally be operating at all times during operation of an exemplary glass manufacturing system. Additional mechanisms (mechanical or otherwise) can be employed downstream of exemplary cooling and heating mechanisms 370 to displace the separated bead outside of a plane formed by the glass ribbon to avoid any ribbon edge damage and avoid motion of the beads due to downstream operations. These additional mechanisms should be activated after crack initiation and then kept operating at all times, and in some embodiments can be placed about 500 mm to 1000 mm downstream of the second set of cooling mechanisms.

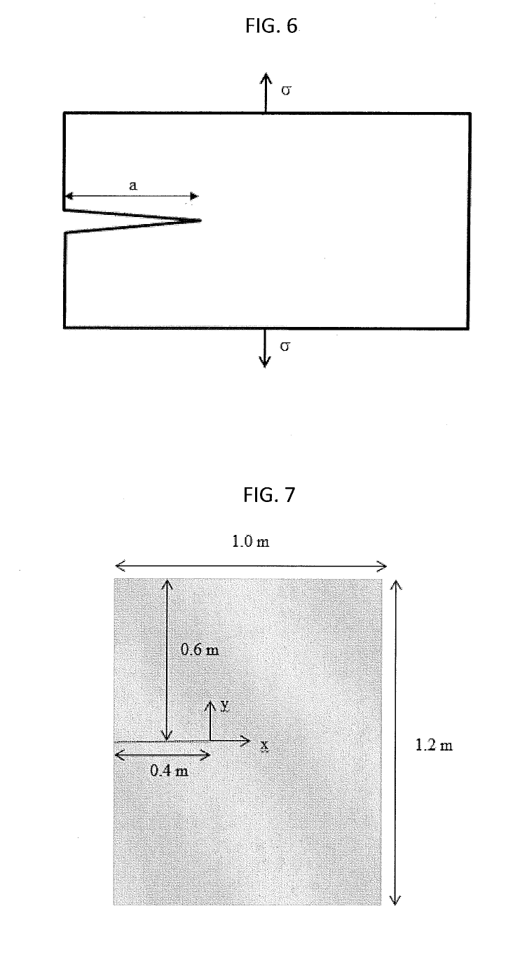

Glass is a brittle material in which elastic fracture mechanics apply. Cracks propagate in such materials when the energy released by advancing the crack is greater than the energy required to create new surface area. This concept can be employed in embodiments described herein by making use of stress intensity factors and fracture toughness. Stress intensity factor can be calculated from the elastic properties of the material, geometry, and loading and summarizes the stress conditions near the tip of the crack. FIG. 6 is a schematic of a through crack of length a in a specimen subjected to uniform tension stress a. Stress intensity factor for the situation shown in FIG. 6 can be provided as K₁ (stress*length) in the equation below.

K₁=1.12σ\sqrt{πa} (1)

Fracture toughness, K_{1c}, is a material property that describes resistance to cracks. When K₁ above exceeds K_{1c}, the crack propagates. It has been discovered, however, that cracks can be stopped by changing stress distribution so that K₁ drops below K_{1c}. FIG. 7 is a schematic of crack stoppage for a specimen. As shown in FIG. 7, a crack represented by the dashed line ends at the coordinate system origin, and the compressive stress lane is generated by a temperature field given by:

$$Δ T ( y ) = Δ {T}_{ma x} exp [ - 4 ln ( 2 ) \frac{{y}^{2}}{{w}^{2}} ] \qquad ( 2 )$$

where ΔTₘₐₓ represents the maximum temperature change in the lane and w represents its width at half maximum. It should be noted that the term “lane” is used generally herein as a portion of a glass ribbon. This portion may be a surface area or may also be a volume in which stresses differ from the stresses of the bulk glass ribbon. Such temperature distributions can result in stress similar to that generated by cooling a narrow strip above the setting zone in a fusion forming process. In the configuration shown in FIG. 7 and with ΔT(y) from Equation (2), K₁ can be determined by finite element model and approximated by the below relationship:

$${K}_{1} = \frac{1.45}{{m}^{0.5}} Ew αΔ {T}_{Ma x} \qquad ( 3 )$$

where E represents the Young's modulus of the glass, α represents the glass coefficient of thermal expansion, and m represents 1 meter. Functional forms of the temperature distribution differing from Equation (2) can also be determined but can still depend on the coordinate y result (ΔT(y)) in Equation (3) having a similar form but different constants.

It should be noted that both width and magnitude of the stress lane are factors in whether cracks propagate and it can be observed from the above relationships that K₁ can be reduced below K_{1c} by reducing ΔTₘₐₓ. In other embodiments, local cooling can be used to reduce K₁ in the configuration depicted in FIG. 7. In further embodiments, temperature in a glass sheet can be modified by adding the effect of a local cooling patch or area to the following relationship:

$$Δ T ( x , y ) = Δ {T}_{ma x} exp [ - 4 ln ( 2 ) \frac{{y}^{2}}{{w}^{2}} ] - Δ {T}_{cool} exp [ - 4 ln ( 2 ) \frac{{y}^{2}}{{w}_{cool}^{2}} - 1.207 \frac{{( \vert x - d \vert )}^{0.8}}{{h}^{0.8}} ] \qquad ( 4 )$$

where w_{cool} represents the width of the cooling patch/area in the y direction, d represents the x coordinate center of the patch/area, and h represents the width of the patch/area in the x direction. The exponent 0.8 can be selected to approximate heat transfer from an exemplary nozzle, burner or jet in a fusion or other glass forming process. For example, in a fusion process the glass sheet is moving in the positive x direction, so the value of h can be selected to be 130 mm when x>d and 15 mm when x≦d. Such a formulation can allow exploration of how cooling can be used to arrest, locate or stop a crack propagating in the −x direction in some embodiments. In other embodiments, crack location or stoppage can occur when K₁<K_{1c}. Fracture toughness for some exemplary oxide glasses can be approximately K_{1c}=0.8 MPa*m^{0.5}. With reference to FIG. 7 and Table 1 below, Stress Intensity Factors are provided for various parameter combinations and embodiments with E=73.6 GPa and α=3.60 ppm/° C. Of course, these Stress Intensity Factors should not limit the scope of the claims appended herewith as various values of Stress Intensity Factors can be determined using a finite element analysis with ΔT(x,y) applied from Equation (4) and the parameters in Table 1.

TABLE 1

| | ΔTₘₐₓ, | w, | ΔT_{cool}, | w_{cool}, | −d, | K₁, |
|---|---|---|---|---|---|---|
| Case | ° C. | mm | ° C. | mm | mm | MPa*m^{0.5} |
| 1 | 130 | 20 | 0 | 0 | 0 | 1.03 |
| 2 | 130 | 20 | 50 | 10 | 600 | 1.03 |
| 3 | 130 | 20 | 50 | 10 | 500 | 0.98 |
| 4 | 130 | 20 | 50 | 10 | 400 | 0.93 |
| 5 | 130 | 20 | 50 | 10 | 300 | 0.87 |
| 6 | 130 | 20 | 50 | 10 | 200 | 0.81 |
| 7 | 130 | 20 | 50 | 10 | 100 | 0.77 |
| 8 | 130 | 20 | 50 | 20 | 100 | 0.58 |
| 9 | 130 | 20 | 75 | 20 | 100 | 0.30 |
| 10 | 130 | 20 | 25 | 20 | 100 | 0.80 |

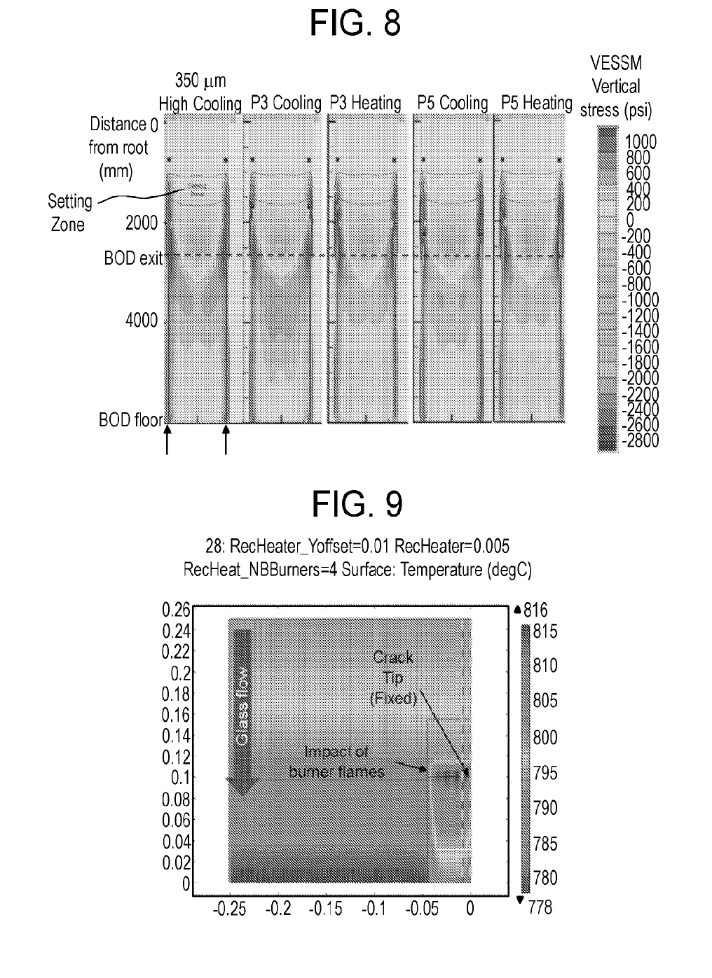

With reference to Table 1, the experiments or cases provided illustrate that a crack can propagate with no cooling (case 1) but can be located or stopped when cooling is applied as in, e.g., cases 6 through 10. In further experiments, a production scale case was conducted and can be observed in FIG. 8. FIG. 8 is a series of stress diagrams showing cooling at certain elevations on a glass ribbon to create residual stress and cooling or heating at various locations for crack location or stoppage. With reference to FIG. 8, normal stress in the vertical direction is plotted with several heating and cooling configurations (e.g., 350 um high cooling, P3 cooling, P3 heating, P5 cooling, P5 heating). These configurations are measured in distance from the root of a forming vessel in mm. In FIG. 8 it can be observed that both heating and cooling of the residual stress lane can be effective at reducing the magnitude of compressive stress in the lane to effectively guide a crack. Furthermore, it was discovered that heating in and near the lane of compressive residual stress can also effectively locate or stop crack propagation in some embodiments. The same formulation used above to analyze cooling can also be used to analyze heating by changing the sign of ΔT_{cool} with the results shown in Table 2 below.

TABLE 2

| | ΔTₘₐₓ, | w, | ΔT_{cool}, | w_{cool}, | −d, | K₁, |
|---|---|---|---|---|---|---|
| Case | ° C. | mm | ° C. | mm | mm | MPa*m^{0.5} |
| 11 | 130 | 20 | 20 | 100 | 40 | 0.96 |
| 12 | 130 | 20 | 20 | 100 | 30 | 0.79 |
| 13 | 130 | 20 | 20 | 100 | 20 | 0.60 |
| 14 | 130 | 20 | 20 | 75 | 40 | 1.00 |
| 15 | 130 | 20 | 20 | 75 | 30 | 0.85 |
| 16 | 130 | 20 | 20 | 75 | 20 | 0.67 |

With reference to Table 2, it can be observed that wider heating zones can, in some embodiments, be more effective at reducing K₁ and that a crack can locate or stop closer to a heating zone than a cooling zone.

It has also been discovered in some embodiments that heating of an area on a glass ribbon near a compressive stress lane can locate or stop a crack by a different mechanism than cooling. While it was found that cooling can directly reduce the compressive stress that causes the crack to propagate, heating in the same area near the compressive stress lane can cause compressive stresses in a direction perpendicular to the compressive stress lane. This compressive stress in the direction perpendicular to the lane can cause the crack to close so that it no longer propagates. Of course, embodiments described herein can employ both cooling and heating alone or together to stop a crack. As has been experimentally demonstrated and discussed herein, vertical cracks can be initiated, propagated and located or stopped in a glass ribbon. This can occur for a single sheet of glass, for a laminate glass ribbon (even though the core of the laminate may be in tension), and for a glass web. Exemplary thicknesses for a glass ribbon or sheet, web or laminate can range from about 0.01 mm to about 5 mm, from about 0.1 mm to about 3 mm, from about 0.1 mm to about 2 mm, from about 0.1 mm to about 1 mm, from about 0.1 mm to about 0.7 mm, from about 0.1 mm to about 0.5 mm, and all subranges therebetween.

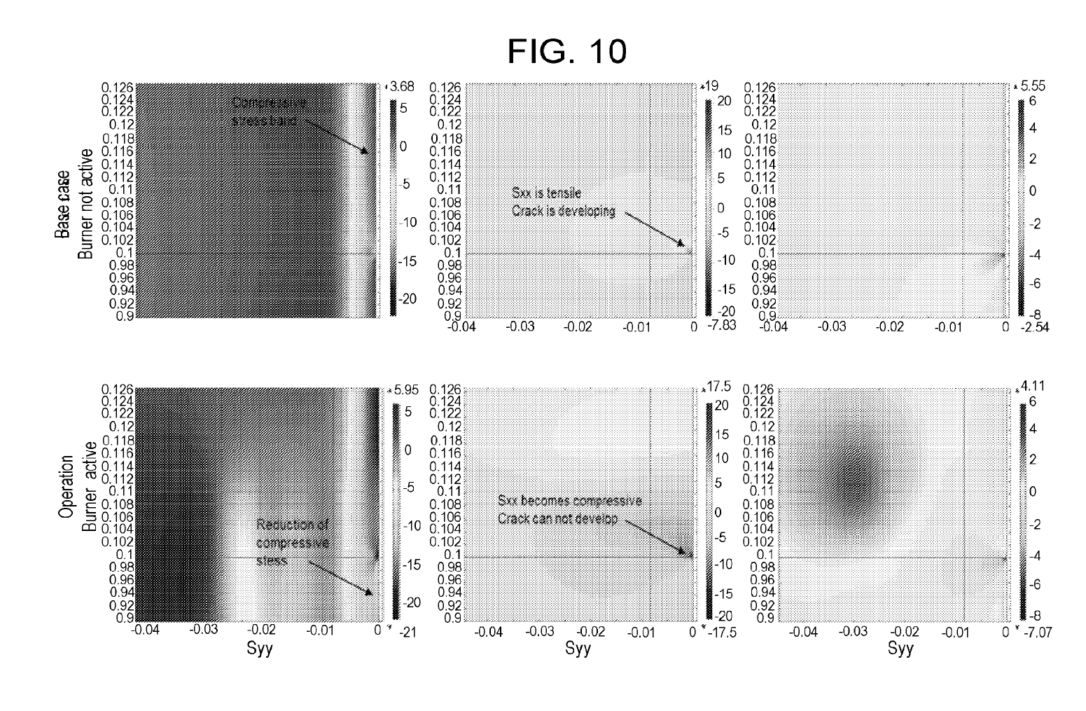

Additional experiments were also conducted using full scale FDMs whereby a heater based on a forming gas burner (H2/N2 5/95 mix) was employed to locally reheat a substrate on both sides of the compressive stress lane. FIG. 9 is a graph showing a thermal model for a crack locating or stopping burner. FIG. 10 is a thermal-mechanical graphical analysis of a glass ribbon with a crack locating or stopping burner. With reference to FIGS. 9 and 10, the thermal impact of burner flames on a flowing glass ribbon can be observed. For example, in FIG. 10, results are provided for a base case where the burner is not active (upper panels) versus an experimental case where the burner is active (lower panels). As can be observed, a crack develops in the base case (e.g., the compressive stress band amplitude is large enough for K₁ to exceed K_{1c}) whereas, in the experimental case, the tensile stress developed at the tip of the crack and its surrounding area were modified to a compressive stress when the burner is activated subsequently locates or stops the crack.

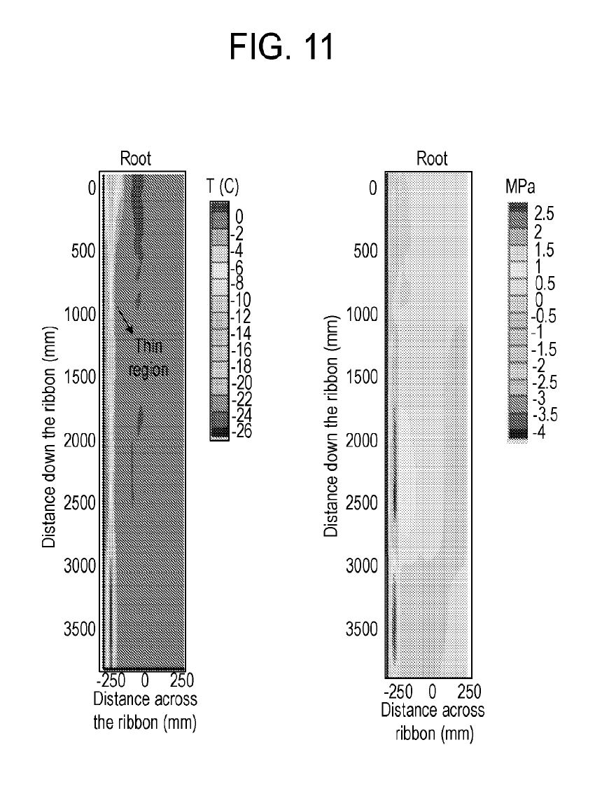

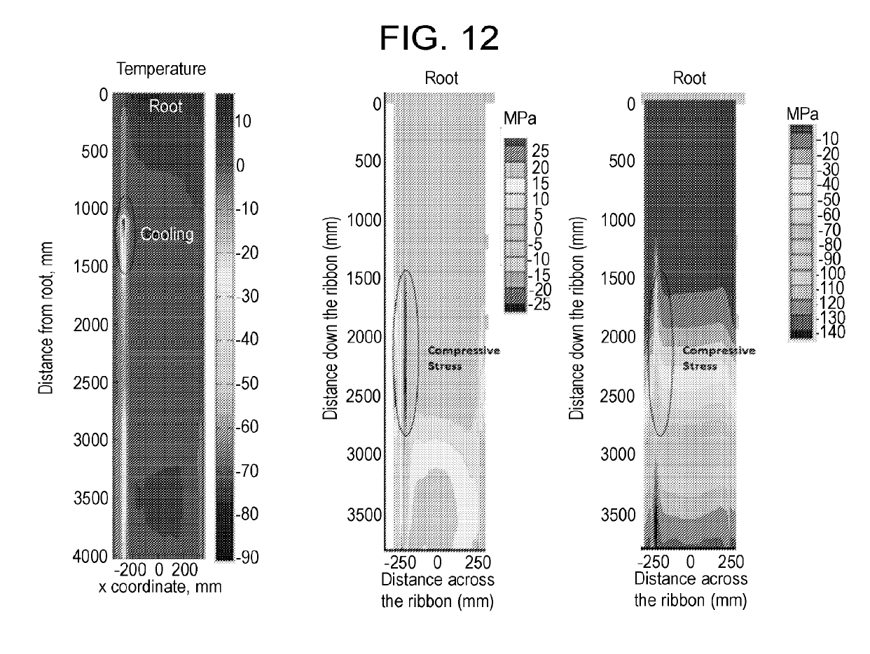

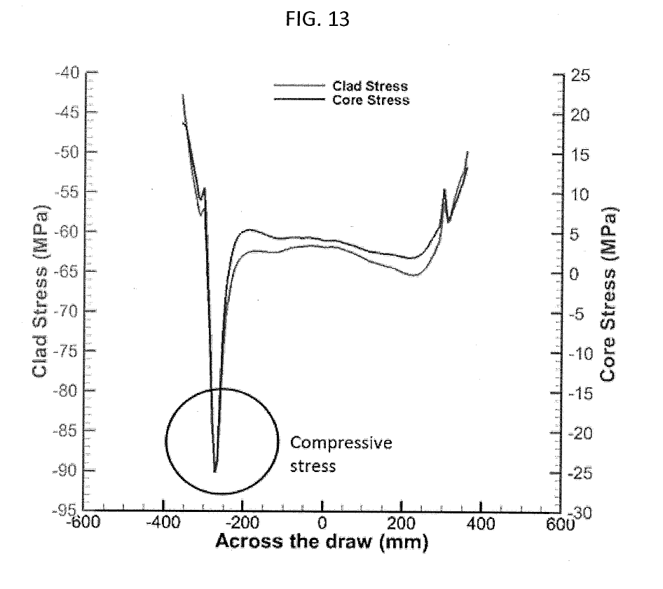

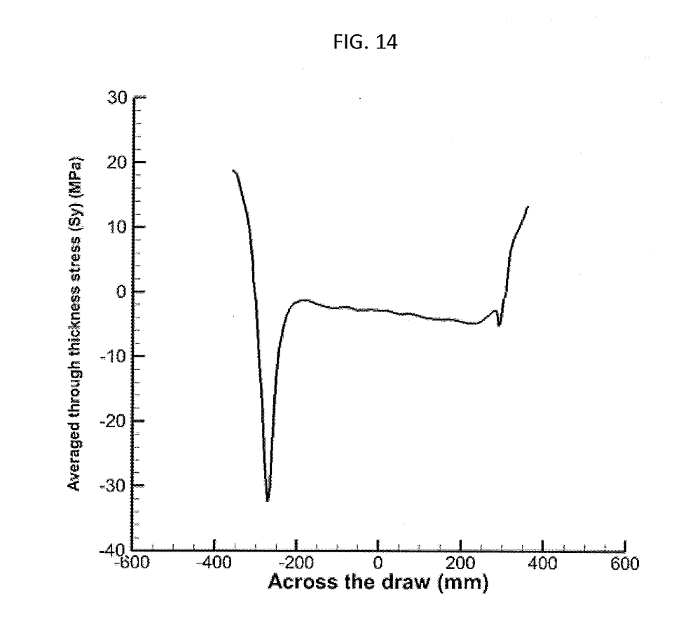

Regarding crack initiation and/or thinning of a glass ribbon, FIG. 11 is a series of plots illustrating temperature differences and induced residual stresses in a glass ribbon due to thinning on a side thereof. With reference to FIGS. 4 and 11, cooling or heating nozzles, jets, lasers, IR heaters, burners 370a-h or the like can be used to ‘thin’ a portion 305 of a glass ribbon 304. FIG. 11 illustrates the effect of thinning of the glass ribbon using an exit gas from a nozzle 370a-h whereby temperature is lower in the thin region or lane thereby producing a compressive residual stress. As can be observed, stress differences arising in the ribbon can be focused which can be used to initiate a crack in the glass ribbon alone or can be used with a mechanical means for initiation as well. The supplied gas may be provided at a temperature in a range from about 20° C. to about 1700° C., in a range from about 500° C. to about 1700° C., in a range from about 700° C. to about 1700° C., in a range from about 750° C. to about 850° C., in a range from about 850° C. to about 1450° C., in a range from about 1450° C. to about 1700° C., and all subranges therebetween. The supplied gas may also be provided at a temperature difference (above or below) with the continuous glass ribbon of between about +/−0.1° C. to about 900° C. and all ranges and subranges therebetween. Of course, the temperature of the supplied can will depend upon the function required for the respective nozzle, i.e., crack initiation, crack propagation or crack location or stoppage. For example, in some embodiments the gas temperature of a heating mechanism should be at least 100° C. to at least 200° C. above the temperature of the glass at a flow viscosity of about 150,000 poise. In glasses having a viscosity of about 140,000 poise, the gas temperature of a heating mechanism should range between about 1040° C. to about 1240° C. Such temperatures and temperature differences can be employed by exemplary embodiments to modify (e.g., reduce) compressive stresses in a glass ribbon from between about 0.1 MPa to greater than about 50 MPa, between about 1 MPa and about 25 MPa, or between about 5 MPa and about 20 MPa and all subranges therebetween. While embodiments have heretofore referenced a glass ribbon, the claims appended herewith should not be so limited as embodiments are applicable to laminate structures (e.g., a core with one or more clad layers, a glass web, or the like). For example, FIG. 12 is another series of plots illustrating temperature differences and induced residual stresses in a glass laminate ribbon due to thinning on a side thereof. With reference to FIG. 12, the effect of cooling at the thin region in a first pulling machine elevation of a laminate glass ribbon can be observed whereby the left panel illustrates a difference in temperature due to cooling in a thinned region, and the right and middle panels illustrate the stresses that arise as a result of the temperature difference. Such high compressive stresses induced by exemplary embodiments can be utilized to initiate a crack and allow the crack to propagate thereby separating undesirable beads. FIGS. 13 and 14 are plots of compressive stress in a laminate ribbon. With reference to FIGS. 13 and 14, high compressive stresses can be observed in the predetermined region, lane or portion 305 where a crack is initiated and propagated upward in an exemplary FDM 350 thereby separating the beads. The crack can then be arrested in the FDM 350 through selective utilization of additional cooling and/or heating nozzles, burners or jets 370 resulting in a sustained bead separation process of a continuous glass ribbon.

Thus, in some embodiments cooling can be described by the following equation

$$\frac{\partial T}{\partial y} = \frac{h}{tU ρ {C}_{p}} ( T - {T}_{a} ) \qquad ( 5 )$$

where T represents glass temperature, y represents the vertical coordinate on ribbon, p represents density Cp represents heat capacity, t represents thickness, U represents vertical ribbon speed, h represents a heat transfer coefficient and Tₐ represents the temperature of cooling media or gas. With reference to Equation (5), it was determined that residual stress generation is directly related to the temperature gradient ∂T/∂y, and it was also determined that temperature change is inversely proportional to thickness. Thus, higher residual stresses can be generated in thinner glass. It should be noted in some embodiments, the residual stress from a given cooling or heating mechanism can depend upon the product of the glass thickness and gas velocity which is proportional to the flow rather and width.

In some embodiments, a nozzle, jet or burner 370 can be installed in an exemplary FDM 350 where a compressive stress lane was created using an air jet impinging upon the glass surface above or in the viscoelastic zone (e.g., in the portion of the ribbon above the pulling rolls). Of course, nozzles, jets or burners 370 can be placed in the elastic region of the glass ribbon (e.g., below the pulling rolls) as well thus such an example should not limit the scope of the claims appended herewith. Gas flow in an exemplary nozzle 370 can be adjusted to control or locate or stop the crack a predetermined locations on the ribbon. For example, in some experiments a gas flow of 20 scfh slowed an advancing crack at about 50 mm from the nozzle center and stopped at approximately 15 mm from the nozzle center. At such an elevation the crack propagation velocity matched the ribbon velocity and the crack was stably located. Exemplary gas flows can range from about 5 scfh to about 50 scfh, from about 10 scfh to about 30 scfh, and all subranges therebetween. It is envisioned that the airflow, along with the temperature of the gas as well as location of the respective nozzles, can be modified to provide suitable thinning of a glass ribbon, suitable modifications to compressive stresses in a glass ribbon, etc. thereby resulting in a controllable and locatable crack. That is, local cooling or heating down the draw (e.g., along the length of the glass ribbon) can be tuned using exemplary embodiments to initiate, propagate, control and locate or stop a crack (vertical or horizontal) in a glass ribbon.

Thus, embodiments described herein address several issues associated with removing edges or beads from a glass ribbon, whether in a fusion forming bead separation processes, from a continuous glass web, slot draw, float, redraw, or from another forming process. One such issue is the stabilization of the location of the crack tip. For example, even small motions of the crack tip along the direction of ribbon motion or perpendicular thereto can cause degradation of edge quality from a minor smooth surface. Larger motions, however, can result in cracks running across the whole ribbon width. Embodiments described herein can provide thermal methods to modify stress around the crack tip to stabilize its position and improve robustness of crack tip location to mechanical disturbances to the ribbon.

Additional embodiments can use residual stresses employed in the ribbon to cause crack propagation rather than any utilization of mechanical shearing or other mechanical methods for crack propagation.

Some embodiments use focused cooling in a thinned region of glass ribbon which induces a high compressive stress in the thinned region. The high residual stress arising by cooling a thin region of glass can create conditions for beads to be separated in a manufacturing process and apparatus or can be used to provide horizontal glass separation. In other embodiments, a focused cooling in a glass transition regime can freeze residual stress which can then facilitate propagation of cracks for separating beads. For certain processes the amount of cooling required to freeze high enough stress to propagate cracks for separation, however, may be impractical and methods have been described herein to locate or stop such propagation. Of course, exemplary embodiments can be used on laminate glass ribbons, single glass ribbons, a continuous glass web, and the like.

Separation of beads in an exemplary fusion draw machine (FDM) using embodiments of the present subject matter can thus open the process window for producing higher quality glass sheets as the shape of the glass ribbon can be more stable and flat and can enable forming processes which generate products with improved attributes such as compaction, warp, stress, etc. Further, separation of beads in such a manner can also reduce the amount of adhered glass on glass sheets normally associated with conventional methods of bead separation (e.g., score and break).

Further embodiments having a glass ribbon with an area, portion, lane or line of compressive stress can also locate or stop a crack propagating upward in that lane by modifying the temperature in a zone near the lane. For example, heating and/or cooling can be selectively employed to stop or locate a propagating crack. Thus, in some embodiments, cooling within a lane of compressive stress guiding a propagating crack can be used to locate or stop the crack, heating the lane of compressive stress and the region immediately surrounding it can be used to locate or stop the crack, or both heating and cooling can be used to locate or stop a propagating crack. Additional embodiments can locate the crack tip in a favorable physical location to thereby isolate the propagating crack from disturbing upstream or downstream ribbon motion.

In some embodiments, location or stoppage of a crack using cooling within a lane of compression can also enhance any residual compressive stress that appears downstream if the cooling is performed within a glass setting zone. Thus, less cooling may be required at the initial, highest location allowing higher glass flow rates with the same cooling equipment.

It should be noted that while some embodiments are described as applicable to fusion forming, the claims appended herewith should not be so limited as the methods, systems and apparatuses described herein can be used on any glass ribbon with a residual stress band causing a crack to propagate.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a component” includes examples having two or more such components unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. Moreover, “substantially similar” is intended to denote that two values are equal or approximately equal. In some embodiments, “substantially similar” may denote values within about 10% of each other, such as within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprises A+B+C include embodiments where an apparatus consists of A+B+C and embodiments where an apparatus consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

1. An apparatus for forming a glass ribbon comprising:
a forming body comprising converging forming surfaces that join at a root of the forming body, the forming body configured to have molten glass forming a continuously moving glass ribbon that is drawn from the root;
a first heating or cooling apparatus to initiate a vertical crack in the continuously moving glass ribbon;
a second heating or cooling apparatus to locate or stop the initiated crack in the continuously moving glass ribbon; and
a separating mechanism downstream of the first and second heating or cooling apparatuses, the separating mechanism configured to horizontally separate the continuously moving glass ribbon into glass sheets.

2. The apparatus of claim 1 wherein the second heating or cooling apparatus is downstream of the first heating or cooling apparatus.

3. The apparatus of claim 1 wherein the first and second heating or cooling apparatuses comprise at least one of a nozzle, jet, a laser, an IR heater and a burner.

4. The apparatus of claim 1 wherein the continuously moving glass ribbon is at a first temperature and wherein the first heating or cooling apparatus is configured to deliver gas to the continuously moving glass ribbon at a second temperature lower than the first temperature.

5. The apparatus of claim 1 wherein the continuously moving glass ribbon is at a first temperature and wherein the first heating or cooling apparatus is configured to deliver gas to the continuously moving glass ribbon at a second temperature higher than the first temperature

6. The apparatus of claim 1 further comprising a third heating or cooling apparatus either downstream of the first and second heating or cooling apparatuses or downstream of the first heating and cooling apparatus and upstream of the second heating or cooling apparatus.

7. The apparatus of claim 4 wherein the gas is selected from the group consisting of air, nitrogen, hydrogen, combustible gases, noble gases and combinations thereof.

8. The apparatus of claim 1 wherein the separating mechanism separates the glass using at least one of a laser mechanism, a mechanical scoring mechanism, and one or more additional heating or cooling apparatuses.

9. The apparatus of claim 1 wherein the continuously moving glass ribbon has a thickness between about 0.01 mm to about 5 mm.

10. The apparatus of claim 1 wherein the second heating mechanism is located between about 2500 mm and about 7500 mm downstream of the root.

11. The apparatus of claim 1 wherein the first heating mechanism is located between about 500 mm and about 5500 mm upstream of the second heating mechanism.

12. A method for manufacturing a glass ribbon comprising the step of using the apparatus of claim 1.

13. An apparatus for forming a glass ribbon comprising:
a forming body comprising converging forming surfaces that join at a root of the forming body, the forming body configured to have molten glass forming a continuously moving glass ribbon that is drawn from the root;
a first heating or cooling apparatus to separate the continuously moving glass ribbon in the direction of flow; and
a second heating or cooling apparatus to locate or stop the separation of the continuously moving glass ribbon before the root.

14. The apparatus of claim 13 further comprising a separating mechanism downstream of the first and second heating or cooling apparatuses, the separating mechanism configured to horizontally separate the continuously moving glass ribbon into glass sheets.

15. The apparatus of claim 13 further comprising a third heating or cooling apparatus either downstream of the first and second heating or cooling apparatuses or downstream of the first heating and cooling apparatus and upstream of the second heating or cooling apparatus.

16. The apparatus of claim 13 wherein the second heating or cooling apparatus is downstream of the first heating or cooling apparatus.

17. The apparatus of claim 13 wherein the first and second heating or cooling apparatuses comprise at least one of a nozzle, jet, a laser, an IR heater and a burner.

18. The apparatus of claim 13 wherein the continuously moving glass ribbon is at a first temperature and wherein the first heating or cooling apparatus is configured to deliver gas to the continuously moving glass ribbon at a second temperature lower than the first temperature.

19. The apparatus of claim 13 wherein the continuously moving glass ribbon is at a first temperature and wherein the first heating or cooling apparatus is configured to deliver gas to the continuously moving glass ribbon at a second temperature higher than the first temperature

20. The apparatus of claim 18 wherein the gas is selected from the group consisting of air, nitrogen, hydrogen, combustible gases, noble gases and combinations thereof.

21. The apparatus of claim 14 wherein the separating mechanism separates the glass using at least one of a laser mechanism, a mechanical scoring mechanism, and one or more additional heating or cooling apparatuses.

22. The apparatus of claim 13 wherein the continuously moving glass ribbon has a thickness after the separating mechanism of between about 0.01 mm to about 5 mm.

23. The apparatus of claim 13 wherein the second heating mechanism is located between about 2500 mm and about 7500 mm downstream of the root.

24. The apparatus of claim 13 wherein the first heating mechanism is located between about 500 mm and about 5500 mm upstream of the second heating mechanism.

25. A method for manufacturing a glass ribbon comprising the step of using the apparatus of claim 13.

26. An apparatus for forming a glass ribbon comprising:
a forming body configured to form a continuously moving glass ribbon that is drawn therefrom;
a first heating or cooling apparatus to initiate a crack in a viscoelastic region of the continuously moving glass ribbon; and
a second heating or cooling apparatus to locate or stop the initiated crack in the continuously moving glass ribbon.

27. The apparatus of claim 26 wherein the forming body further comprises converging forming surfaces that join at a root of the forming body, the forming body being configured to have molten glass forming a continuously moving glass ribbon that is drawn from the root.

28. The apparatus of claim 26 wherein the initiated crack is in the direction of flow.

29. The apparatus of claim 26 wherein the initiated crack is perpendicular to the direction of flow.

30. The apparatus of claim 26 further comprising a separating mechanism downstream of the first and second heating or cooling apparatuses, the separating mechanism configured to separate the continuously moving glass ribbon into glass sheets.

31. The apparatus of claim 26 wherein the second heating or cooling apparatus is downstream of the first heating or cooling apparatus.

32. The apparatus of claim 26 further comprising a third heating or cooling apparatus either downstream of the first and second heating or cooling apparatuses or downstream of the first heating and cooling apparatus and upstream of the second heating or cooling apparatus.

33. The apparatus of claim 26 wherein the first and second heating or cooling apparatuses comprise at least one of a nozzle, jet, a laser, an IR heater and a burner.

34. The apparatus of claim 26 wherein the continuously moving glass ribbon is at a first temperature and wherein the first heating or cooling apparatus is configured to deliver gas to the continuously moving glass ribbon at a second temperature lower than the first temperature.

35. The apparatus of claim 26 wherein the continuously moving glass ribbon is at a first temperature and wherein the first heating or cooling apparatus is configured to deliver gas to the continuously moving glass ribbon at a second temperature higher than the first temperature.

36. The apparatus of claim 34 wherein the gas is selected from the group consisting of air, nitrogen, hydrogen, combustible gases, noble gases and combinations thereof.

37. The apparatus of claim 30 wherein the separating mechanism separates the glass using at least one of a laser mechanism, a mechanical scoring mechanism, and one or more additional heating or cooling apparatuses.

38. The apparatus of claim 26 wherein the continuously moving glass ribbon has a thickness of between about 0.01 mm to about 5 mm.

39. The apparatus of claim 27 wherein the second heating mechanism is located between about 2500 mm and about 7500 mm downstream of the root.

40. The apparatus of claim 26 wherein the first heating mechanism is located between about 500 mm and about 5500 mm upstream of the second heating mechanism.

41. A method for manufacturing a glass ribbon comprising the step of using the apparatus of claim 26.

42. The apparatus of claim 1, 14 or 26 wherein the first heating or cooling apparatus is upstream from a portion of the glass ribbon at its respective glass transition temperature.
